(19) United States
(12) Patent Application Publication
(10) Pub. No.: US 2014/0320369 A1
(43) Pub. Date: Oct. 30, 2014

(54) SHIELDING LAYER FOR A DEVICE HAVING A PLURALITY OF ANTENNAS

(71) Applicant: BROADCOM CORPORATION, Irvine, CA (US)

(72) Inventors: Ntsanderh (Christian) Azenui, Irvine, CA (US); John Walley, Ladera Ranch, CA (US)

(21) Appl. No.: 13/911,174

(22) Filed: Jun. 6, 2013

Related U.S. Application Data
(60) Provisional application No. 61/815,602, filed on Apr. 24, 2013.

(51) Int. Cl. H01Q 1/52

(52) U.S. Cl. CPC H01Q 1/526
USPC 343/841; 29/600

(57) ABSTRACT

A shielding layer is provided that reduces the coupling between magnetic field lines emanating from a plurality of antennas in an electronic device. In one embodiment, the shielding layer is a heterogeneous shielding layer that has different regions. Each region is configured to be positioned adjacent to a respective antenna. Each region is a different type of material, has a different thickness, and/or has other non-uniformities (e.g., different permeabilities) to concentrate magnetic field lines in accordance to the properties of the respective antenna. In another embodiment, a heterogeneous shielding layer is provided that has different regions that are formed of a same material that is configured to concentrate magnetic field lines. Each region is configured to be positioned adjacent to a respective antenna. The different regions are separated by gap to isolate the magnetic field lines emanating from the respective antenna, which reduces the coupling between the magnetic field lines.

### CROSS REFERENCE TO RELATED APPLICATION

This application claims priority to U.S. Provisional Application Ser. No. 61/815,602, filed Apr. 24, 2013, the entirety of which is incorporated by reference herein.

### BACKGROUND

1. Technical Field

The present invention relates to magnetic shielding technology.

2. Background Art

The ownership and use of mobile devices, such as smart phones, are becoming increasingly widespread around the world. A current trend is the addition of more and more functions to these mobile devices to provide a wider variety of services. Such new functions include NFC (near field communication) and wireless power transfer (WPT) technologies. NFC enables wireless communications between devices located in close proximity. WPT enables the charging of batteries of a device without a physical connection between a charger and the device. NFC and WPT each require an antenna. Accordingly, mobile device technology is moving towards including a plurality of antennas (e.g., a first antenna for NFC and a second antenna for WPT).

During use, magnetic field lines emanate from each antenna included in a mobile device. Without proper shielding, the magnetic field lines from each antenna may cross each other, thereby resulting in a coupling effect that reduces the performance of the antennas. Additionally, these magnetic field lines may interfere with other circuitry and/or components of the mobile device. For example, a battery may be in close proximity with a WPT antenna. Without proper shielding, the magnetic field lines produced by the WPT antenna and/or any other antenna included in the electronic device may induce eddy currents that flow through the battery. This may result in a reduced charging efficiency of the battery and/or an undesirable heating of the battery.

### BRIEF SUMMARY

Methods, systems, and apparatuses are described for shielding magnetic field lines emanating from a plurality of antennas of a device, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 depicts a block diagram of an electronic device, according to an example embodiment.

FIG. 2A shows an overhead view of a heterogeneous shielding layer, according to an embodiment.

FIG. 2B shows a cross-sectional view of a heterogeneous shielding layer, according to an embodiment.

FIG. 2C shows a cross-sectional view of a heterogeneous shielding layer, according to another embodiment.

FIG. 2D shows a cross-sectional view of a heterogeneous shielding layer, according to another embodiment.

FIG. 2E shows a cross-sectional view of a heterogeneous shielding layer, according to another embodiment.

FIG. 3 shows a flowchart providing example steps for forming a heterogeneous shielding layer, according to an example embodiment.

FIG. 4 shows an example step for forming a gap in a heterogeneous shielding layer, according to an example embodiment.

FIG. 5 shows an example assembly including a heterogeneous shielding layer and a plurality of antennas, according to an example embodiment.

FIG. 6 depicts a block diagram of an electronic device, according to another example embodiment.

FIG. 7A shows an overhead view of a heterogeneous shielding layer, according to another embodiment.

FIG. 7B shows a cross-sectional view of a heterogeneous shielding layer, according to an embodiment.

FIG. 7C shows a cross-sectional view of a heterogeneous shielding layer, according to another embodiment.

FIG. 7D shows a cross-sectional view of a heterogeneous shielding layer, according to another embodiment.

FIG. 8 shows a flowchart providing example steps for forming a heterogeneous shielding layer, according to another example embodiment.

FIG. 9 shows an example assembly including a heterogeneous shielding layer and a plurality of antennas, according to another example embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

In embodiments, a shielding layer is provided that reduces the coupling between magnetic field lines emanating from a plurality of antennas in an electronic device. In one embodiment, the shielding layer is a heterogeneous shielding layer that has different regions. Each region is configured to be positioned adjacent to a respective antenna. Each region is a different type of material, has a different thickness, and/or has other non-uniformities (e.g., different permeabilities) to concentrate magnetic field lines in accordance to the properties of the respective antenna. In another embodiment, a heterogeneous shielding layer is provided that has different regions that are formed of a same material that is configured to concentrate magnetic field lines. Each region is configured to be positioned adjacent to a respective antenna. The different regions are separated by gap to isolate the magnetic field lines emanating from the respective antenna, which reduces the coupling between the magnetic field lines.

For example, apparatuses are described herein. In accordance with an embodiment, an apparatus includes a shielding layer that is formed of at least one material. The material is configured to concentrate magnetic field lines. The shielding layer includes a first region that has a first characteristic and a second region that has a second characteristic that is different from the first characteristic. The first region is configured to be positioned adjacent to at least a first antenna, and the second region is configured to be positioned adjacent to at least a second antenna.

In accordance with another embodiment, the apparatus includes a shielding layer that has at least two regions separated by a gap. The at least two regions may or may not be formed of a same material and are configured to concentrate magnetic field lines. The shielding layer is configured to be positioned adjacent to a plurality of antennas.

Furthermore, methods for forming a shielding layer are described herein. In accordance with an example method, a first region of the shielding layer that covers a first portion of a substrate is formed. The first region has a first characteristic. A second region of the shielding layer having a second characteristic that covers a second portion of the substrate is formed. The first portion covered by the first region is different from the second portion covered by the second region.

Examples of these embodiments and further embodiments are described in the following sub-sections.

Some electronic devices may include a magnetic shielding layer that is configured to concentrate magnetic field lines emanating from an adjacently positioned antenna to shield other circuitry and/or components of such electronic devices from the magnetic field lines. For example, an antenna included in an electronic device may be a wireless charging coil configured to wirelessly charge a battery included in the electronic device. The battery may be in close proximity of the wireless charging coil. As such, without proper shielding, the magnetic field lines produced by the wireless charging coil and/or the other antenna(s) included in the electronic device may induce eddy currents that flow through the battery. This may result in a reduced charging efficiency of the battery and/or an undesirable heating of the battery. Additionally, the magnetic field lines emanating from each antenna may cause a coupling effect, which reduces the performance of the antennas. To prevent such drawbacks, in various embodiments disclosed herein, a shielding layer is provided that is configured to reduce the coupling between magnetic field lines emanating from one or more antennas included in an electronic device and to prevent such magnetic field lines from interfering with circuitry and other components of such electronic device.

For example, in embodiments, heterogeneous patterns may be implemented in a magnetic shield to increase isolation for the antennas. Such heterogeneous patterns may be implemented to create uniformities along the x-y dimensions or axes in the magnetic shield (in the plane of the magnetic shield), while the magnetic shield is uniform or not uniform along the z-axis (the thickness of the magnetic shield, which is the shortest dimension of the magnetic shield). Examples of such patterns include patterns of regions of different materials in the magnetic shield, patterns of regions of different permeabilities in the magnetic shield, patterns of regions of different thickness in the magnetic shield, patterns of grooves, slits, or gaps in the magnetic shield, and/or further types of patterns in the magnetic shield. In this manner a heterogeneous shielding layer is created, which is different from conventional homogeneous magnetic shields that tend to be planar, featureless, and uniformly made of a same material.

Example Heterogeneous Shielding Layer Having Regions with Different Characteristics

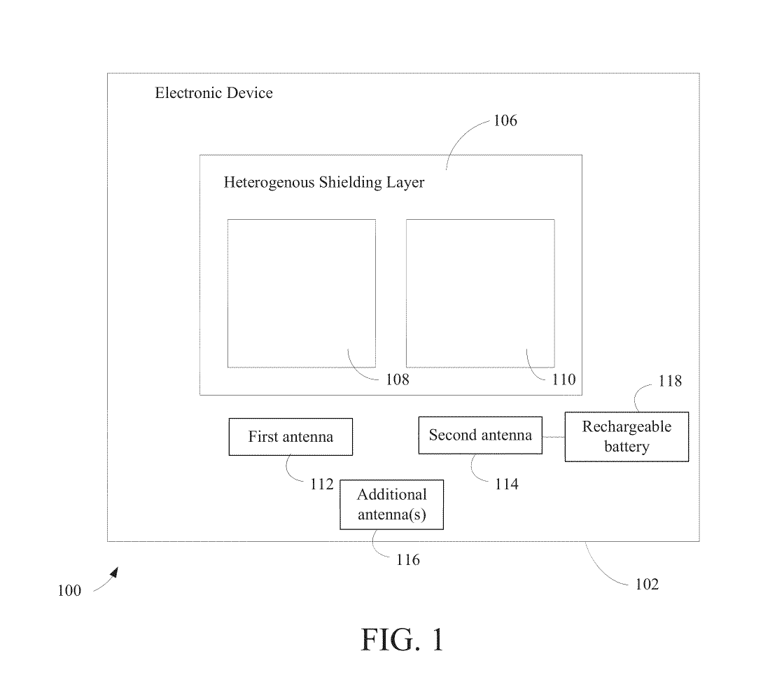

FIG. 1 depicts a block diagram 100 of an electronic device 102, according to an example embodiment. Electronic device 102 may be a device such as, but not limited to, a mobile device including a cell phone (e.g., a smart phone), a tablet, a netbook, a personal data assistant (PDA), a laptop computer, a handheld computer, or other mobile device, or may be a stationary device such as a desktop computer, and/or the like. Electronic device 102 may include further features that are not shown in FIG. 1 for ease of illustration.

As shown in FIG. 1, electronic device 102 includes a heterogeneous shielding layer 106, a first antenna 112, a second antenna 114, and one or more optional additional antennas 116 contained in and/or mounted to a housing of electronic device 102. Heterogeneous shielding layer 106 is a magnetic shield configured to have one or more regions, such as a first region 108 and a second region 110, which have different characteristics from each other. Heterogeneous shielding layer 106 may be formed of at least one material (e.g., a ferrite material) that is configured to concentrate magnetic field lines emanating from one or more of antennas 112, 114, and 116 positioned adjacently to (e.g., situated on top of, on bottom of, next to, etc.) heterogeneous shielding layer 106 to reduce the coupling between such magnetic field lines and to prevent such magnetic field lines from interfering with other components of electronic device 102. For example, one of the antennas included in electronic device 102, such as second antenna 114, may be a wireless charging coil (e.g., a wireless power transfer (WPT) antenna) configured to wirelessly charge a rechargeable battery 118 included in electronic device 102. As such, without proper shielding, the magnetic field lines produced by the wireless charging coil and/or the additional antennas included in electronic device 102 may induce eddy currents that flow through the battery, which may result in a reduced charging efficiency of the battery and/or an undesirable heating of the battery. Thus, in an embodiment, heterogeneous shielding layer 106 may be configured to concentrate magnetic field lines emanating from one or more antennas included in electronic device away from the battery included in electronic device 102.

Because antennas may have different properties, for example, operating at different frequencies, having different physical dimensions, etc., each antenna may emanate magnetic field lines at varying strengths and/or directions. As such, a uniform shielding layer may not effectively shield magnetic field lines emanating from each antenna. That is, such a shielding layer may shield magnetic field lines emanating from one antenna more effectively than magnetic field lines emanating from another antenna. To prevent such a deficiency, each of the one or more regions of heterogeneous shielding layer 106 may be configured to have one or more different characteristics such that each region concentrates magnetic field lines emanating from a respective antenna situated thereon in accordance to the properties of the respective antenna.

Accordingly, as shown in FIG. 1, heterogeneous shielding layer 106 includes first region 108 and second region 110. First region 108 may be configured to concentrate magnetic field lines emanating from first antenna 112 positioned adjacently thereto. Second region 110 may be configured to concentrate magnetic field lines emanating from second antenna 114 positioned adjacently thereto. First region 108 and second region 110 may have one or more different characteristics from each other. For example first region 108 and second region 110 may be made out of different materials, have different thicknesses and/or different permeabilities. “Permeability” refers a degree of magnetization that a material obtains in response to an applied magnetic field, and is typically expressed as “μ” (in units of henries per meter). The higher the value of permeability, the higher amount of magnetization that the material obtains in response to an applied magnetic field.

The characteristics for each region may be dependent on the properties of the respective antenna positioned adjacently thereto. For example, if the strength of the magnetic field lines that emanate from first antenna 112 positioned adjacently to first region 108 is greater than the strength of the magnetic field lines that are emanated from second antenna 114 positioned adjacently to second region 110, first region 108 may be made out of a first material that is more effective at concentrating magnetic field lines (e.g., higher permeability, greater thickness, etc.) than a second material from which second region 110 is made. In addition to or in lieu of being made out of different materials, first region 108 may also be thicker and/or have a permeability greater than second region 110 to be configured to handle a greater strength magnetic field than second region 110.

The variation in permeability among first region 108 and second region 110 may also be based on the radio frequency (RF) field of the respective antennas positioned adjacently thereto. Shielding layers may be configured such that they are more effective at concentrating magnetic field lines emanating from an antenna operating at certain frequencies. Thus, first region 108 may have a permeability that is effective at concentrating magnetic field lines emanating from first antenna 112 operating at a first frequency, and second region 110 may have a permeability that is effective at concentrating magnetic field lines emanating from second antenna 114 operating at a second frequency that is different that the first frequency.

In the example shown above in FIG. 1, heterogeneous shielding layer 106 includes two rectangular regions (i.e., first region 108 and second region 110) that are situated adjacent to each other. In alternative embodiments, heterogeneous shielding layer 106 may include any number of regions having their own respective characteristics (e.g., having one or more additional regions corresponding to optional antenna(s) 116). In addition, each of these regions may have other shapes, such as being, round, triangular, polygonal, irregularly shaped, etc. Moreover, each of these regions may be positioned in any manner.

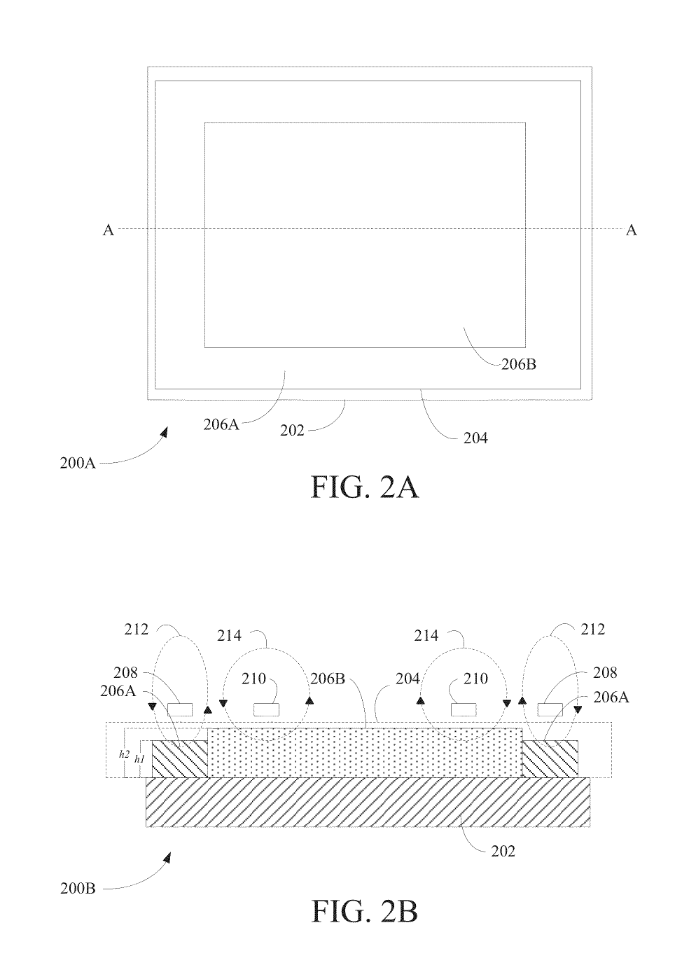

For instance, FIGS. 2A-2E show views of heterogeneous shielding layers according to various example embodiments. In one example, FIG. 2A shows an overhead view 200A of heterogeneous shielding layer 204, where a first region 206A of heterogeneous shielding layer 204 rings (e.g., surrounds) a second region 206B of heterogeneous shielding layer 206. FIG. 2B-2E show cross-sectional views 200B-200E of heterogeneous shielding layer 204 along the line A-A of overhead view 200A of FIG. 2A in accordance to various embodiments.

As shown in FIGS. 2A-2E, heterogeneous shielding layer 204 may be formed over or attached to a substrate 202. Substrate 202 is a physical material upon which a device, such as a semiconductor device (e.g., an integrated circuit), one or more antennas, and/or or one or layers of material (e.g., one or more magnetic shield layers, etc.) are applied. Examples of substrate 202 include a printed circuit board (PCB), or any other support structure known in the art used to support semiconductor devices and hereinafter developed for performing functions of a printed circuit board. The term “printed circuit board” is defined as a board used to mechanically support and electrically connect electronic components using conductive pathways, tracks or signal traces etched from sheets of conductive material (e.g., one or more metals such as copper, aluminum, etc.) laminated onto a non-conductive substrate (e.g., plastic, fiberglass, or any other dielectric suitable to serve as a non-conductive substrate for a printed circuit board). It is noted that substrate 202 is optional and not required in all embodiments. It is further noted that additional materials and/or layers (e.g., adhesive layers) may be present in between and/or affixed adjacently to substrate 202 and/or heterogeneous shielding layer 204 that are not shown in FIGS. 2A-2E for ease of illustration. For instance, an adhesive layer (e.g., an epoxy, a laminate material, a glue, or other adhesive material) may be between heterogeneous shielding layer 204 and substrate 202 to adhere them together.

Heterogeneous shielding layer 204 may be formed of at least one material that is configured to concentrate magnetic field lines. In one embodiment, the at least one material may be a ferrite material. To reduce the coupling between a first antenna and a second antenna positioned adjacently thereto (e.g., first and second antennas 112 and 114 of FIG. 1), first region 206A may be configured to concentrate magnetic field lines emanating from the first antenna into second region 206B, and second region 206B may be configured to concentrate magnetic field lines emanating from the second antenna into first region 206A.

For example, FIG. 2B shows a cross-sectional view of one loop (or coil) of a first antenna 208 positioned adjacent to first region 206A and of one loop of a second antenna 210 positioned adjacent to second region 206B. Additional loops/coils of antennas 208 and 210, which may be present, are not shown in FIG. 2B for ease of illustration. Furthermore, for ease of illustration, antennas 208 and 210 are not shown in FIGS. 2A, 2C, 2D, and 2E. As shown in FIG. 2B, first magnetic field lines 212 generated by first antenna 208 are concentrated in first region 206A, and second magnetic field lines 214 generated by second antenna 210 are concentrated in second region 206B.

First region 206A and second region 206B may have different characteristics. For example, in an embodiment, first region 206A may have a first permeability, and second region 206B may have a second permeability that is different from the first permeability. In another embodiment, first region 206A may be formed of a first material and second region 206B may be formed of a second material that is different from the first material. For example, the first material may comprise a first ferrite material, and the second material may comprise a second ferrite material that is different from the second ferrite material. In another example, the first material may comprise a first iron-metal alloy (e.g., iron-nickel), and the second material may comprise a second iron-metal alloy that is different from the second ferrite material (e.g., has a different metal, is comprised by a different concentration of the same metal, etc.)

In yet another embodiment, first region 206A may have a first thickness and second region 206B may have a second thickness that is different than the first thickness. For example, as shown in FIG. 2B, first region 206A has a first thickness of h1 and second region 206B has a second thickness of h2, which is greater than h1. In this embodiment, second region 206B is configured to be positioned adjacently to an antenna that emanates magnetic field lines that are stronger than the magnetic field lines that emanate from an antenna that is positioned adjacently to first region 206A.

In contrast, as shown in FIG. 2C, first region 206A has a first thickness of h2 and second region 206B has a second thickness of h1, which is less than h2. In this embodiment, first region 206A is configured to be positioned adjacently to an antenna that emanates magnetic field lines that are stronger than the magnetic field lines that emanate from an antenna that is positioned adjacently to second region 206B.

In another example, as shown in FIG. 2D, first region 206A and second region 206B may have the same thickness h. In accordance with this embodiment, first region 206A and second region 206B may be characteristically different in that first region 206A and second region 206 comprise different materials and/or have different permeabilities.

In a further embodiment, portions of first region 206A and/or second region 206B may have varying thicknesses. For example, as shown in FIG. 2E, first region 206A has a first portion 208A that has a thickness of h1 and a second portion 208B that has a thickness of h2 that is greater than h1. Similarly, second region 206B has a first portion 210A that has a thickness of h1 and a second portion 210B that has a thickness of h2 that is greater than h1. In this embodiment, an antenna that is positioned adjacently to first region 206A and/or second region 206B may emanate magnetic field lines in a non-uniform manner (e.g., the strength of the magnetic field lines may vary). Thus, first region 206A and/or second region 206B may be patterned to have varying thicknesses to effectively concentrate such magnetic field lines.

In yet another embodiment, in addition to having different characteristics for first region 206A and second region 206B, a gap that separates first region 206A and second region 206B may be formed to further reduce the coupling between an antenna positioned adjacently to first region 206A and an antenna positioned adjacently to second region 206B. The gap may be formed using any suitable method, including by etching, etc.

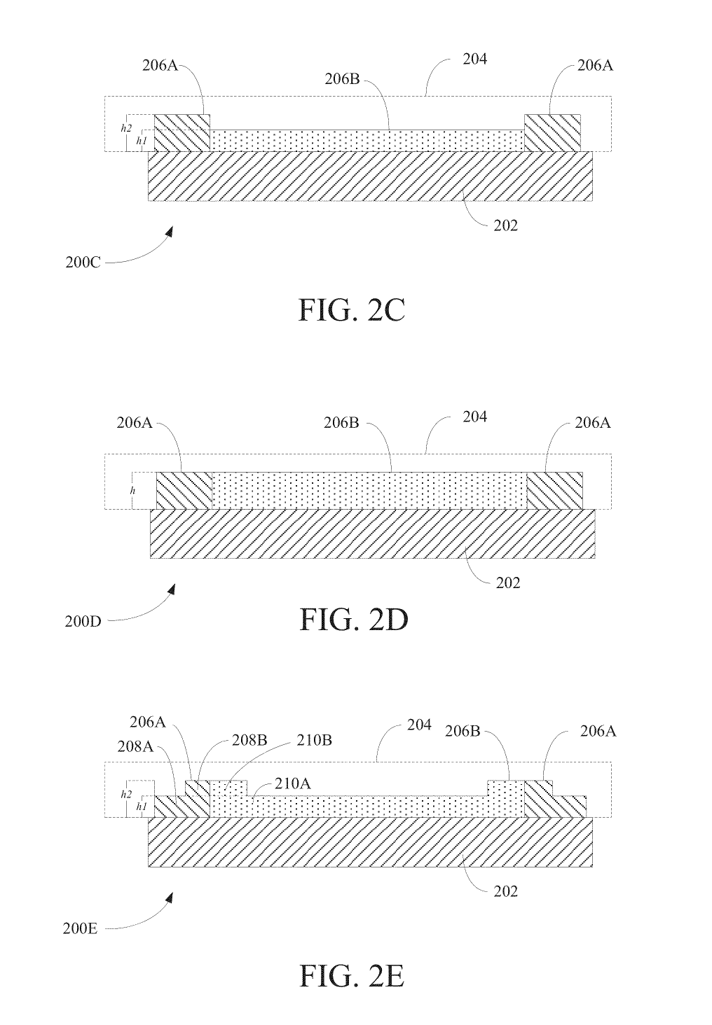

Such heterogeneous shield layers may be formed in any suitable manner. For instance, FIG. 3 shows a flowchart 300 providing example steps for forming a heterogeneous shield layer, according to an example embodiment. For instance, heterogeneous shield layers 106 (FIG. 1) and 204 (FIGS. 2A-2E) may be formed according to flowchart 300. Flowchart 300 is described as follows.

As shown in FIG. 3, flowchart 300 begins with step 302. In step 302, a first region of a shielding layer that covers a first portion of a substrate is formed. The first region has a first characteristic and is configured to be positioned adjacent to a first antenna. For example, with reference to FIG. 2A, first region 206A of heterogeneous shielding layer 204 is formed over an outer portion of substrate 202.

In step 304, a second region of a shielding layer that covers a second portion of the substrate is formed. The first portion of the substrate is different than the second portion of the substrate. The second region is configured to be positioned adjacent to a second antenna. For example, with reference to FIG. 2A, first region 206B of heterogeneous shielding layer 204 is formed over an inner portion of substrate 202.

Note that in embodiments, steps 302 and 304 may be performed separately or simultaneously. First and second regions 206A and 206B may be formed in any manner, including by flowing the corresponding base materials into a mold and allowing the materials to harden to form first and second regions 206A and 206B, by cutting, milling, or otherwise shaping each of first and second regions 206A and 206B from a respective base solid material, and/or by forming first and second regions 206A and 206B in another manner, and by combining first and second regions 206A and 206B together. First and second regions 206A and 206B may be held together with or without an adhesive, by being mounted to substrate 202, and/or by being combined in another manner.

In an embodiment, the first characteristic of the first region of the shielding layer is a first permeability and the second characteristic of the second region of the shielding layer is a second permeability that is different from the first permeability.

In accordance with another embodiment, the first characteristic of the first region of the shielding layer is a first thickness and the second characteristic of the second region of the shielding layer is a second thickness that is different from the first thickness. For example, with reference to FIG. 2B, first region 206A has a first thickness of h1 and second region 206B has a second thickness of h2 that is greater than h1. With reference to FIG. 2C, first region 206A has a first thickness of h2 and second region 206B has a second thickness of h1 that is less than h2.

In accordance with yet another embodiment, the shielding layer comprises at least one material, such as, for example, a ferrite material that is configured to concentrate magnetic field lines.

In accordance with a further embodiment, the shielding layer comprises at least two materials that are each configured to concentrate magnetic field lines. The first region comprises a first material of the at least two materials, and the second region comprises a second material of the at least two materials that is different than the first material. In accordance with this embodiment, the first material comprises a first ferrite material, and the second material comprises a second ferrite material that is different from the first ferrite material.

In accordance with yet another embodiment, the first region rings the second region so that the first region can be proximate to one or more coils of the first antenna, which may ring or loop around the second antenna. For example, with reference to FIG. 2A, first region 206A rings second region 206B. As shown in FIG. 2B, first antenna 208 rings around second antenna 210.

In accordance with a further embodiment, the first antenna may be a near field communication (NFC) antenna, and the second antenna may be a wireless power transfer (WPT) antenna. Alternatively, the first antenna may be a WPT antenna, and the second antenna may be an NFC antenna. In other embodiments, the first antenna and/or second antenna may be other antennas of an electronic device, such as an antenna used for cellular communications, network communications (e.g., Wifi, wireless local area network (WLAN) communications, personal area network (PAN) communications such as Bluetooth, etc.), other far field communications, and/or further types of communications.

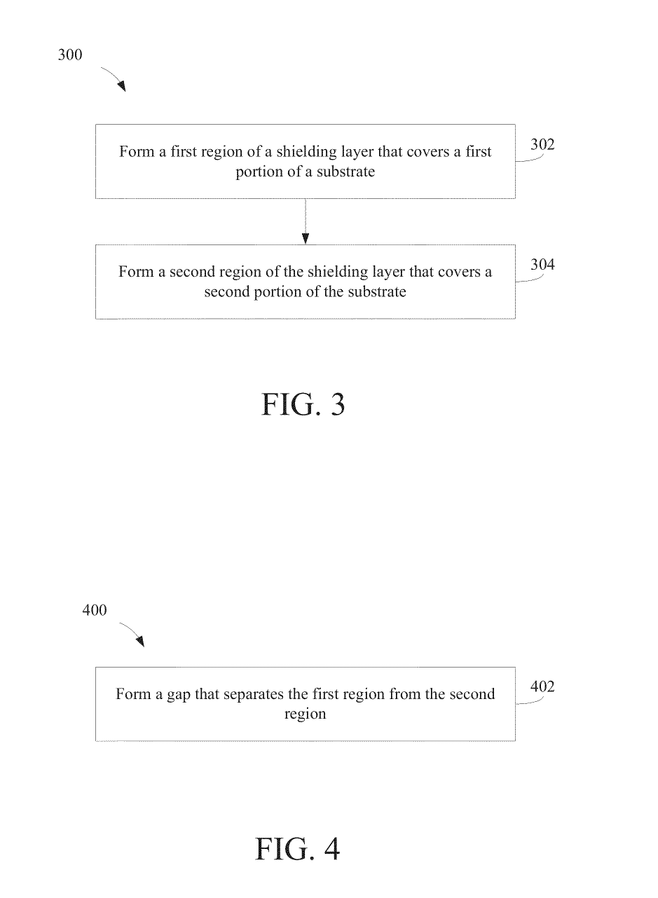

In embodiments, additional techniques may be used to further reduce the coupling between antenna(s) positioned adjacently to the first region and second region of the shielding layer. For instance, FIG. 4 shows a step 402 providing an example process for one such technique. In step 402, a gap is formed that separates a first region of the shielding layer from a second region of the shielding layer. The gap may be formed to entirely separate the first region and the second region, or may be formed partially through the heterogeneous shielding layer (e.g., may have a depth that is less than a thickness of the heterogeneous shielding layer). Example embodiments for forming such gaps, advantages thereof, and other aspects of forming a gap in a shielding layer are described in the next section, and are applicable to embodiments of heterogeneous shielding layers having regions with different characteristics.

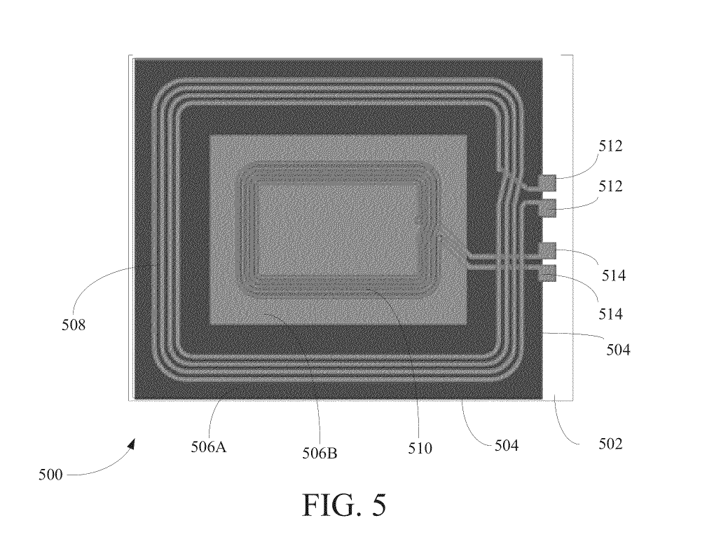

FIG. 5 shows an example assembly 500 including a heterogeneous shielding layer and a plurality of antennas in accordance with embodiments described herein. As shown in FIG. 5, assembly 500 includes a substrate 502, a heterogeneous shielding layer 504, a first antenna 508, and a second antenna 510. Substrate 502 includes heterogeneous shielding layer 504 formed thereon. Heterogeneous shielding layer 504 includes a first region 506A and a second region 506B. First region 506A is positioned adjacent to first antenna 508. For example, as shown in FIG. 5, first antenna 508 is situated on top of first region 506A. Second region 506B is positioned adjacent to second antenna 510. For example, as shown in FIG. 5, second antenna 510 is situated on top of second region 506B.

While FIG. 5 depicts first antenna 508 as being irregularly shaped (being a rectangular shape with rounded corners and other rounded portions) and depicts second antenna 510 as being a rectangular shape with rounded corners, it is noted that first antenna 508 and second antenna 510 may have other shapes, such as being round, triangular, polygonal, etc.

Assembly 500 further includes first connectors 512 and second connectors 514. First connectors 512 includes a pair of conductive traces coupled to the ends of first antenna 508. Second connectors 514 includes a pair of conductive traces coupled to the ends of second antenna 510. First connectors 512 and second connectors 514 are configured to couple first antenna 508 and second antenna 510, respectively, to other circuitry of the device in which assembly 500 is housed. In the example of FIG. 5, first and second connectors 512 and 514 extend past an edge of heterogeneous shielding layer 504 to circuitry 516. First connectors 512 and second connectors 514 are located on a different plane with first antenna 508 and second antenna 510 (i.e., they are not coplanar with first antenna 508 and second antenna 510) to prevent a short circuit between first and second connectors 512, 514 and first and second antennas 508, 510.

First region 506A and second region 506B have different characteristics. For example, first region 506A and second region 506B may be comprised of different materials (e.g., different ferrite materials), may have different thicknesses, and/or may have different permeabilities with respect to each another. The characteristics of each of first region 506A and second region 506B may be dependent on the properties of the respective antenna situated thereon.

For example, in one embodiment, first antenna 508 may be an NFC antenna, and second antenna 510 may be a WPT antenna. WPT antennas have been shown to emanate stronger magnetic field lines than NFC antennas. As such, second region 506B may be configured to comprise a ferrite material, have a thickness, and/or have a permeability that is more suitable to concentrate the stronger magnetic field lines emanating from second antenna 510. In contrast, first region 506A may be configured to comprise a ferrite material, have a thickness, and/or have a permeability that is more suitable to concentrate the weaker magnetic field lines emanating from first antenna 508.

In accordance with an embodiment, first region 506A may be configured to concentrate magnetic field lines emanating from first antenna 508 away from second region 506B, and second region 506B may be configured to concentrate magnetic field lines emanating from second antenna 510 away from first region 506B. First region 506A may also be configured to concentrate magnetic field emanating from first antenna 508 away from certain circuitry and/or components (e.g., a battery) situated proximately to first antenna 508. Similarly, second region 506B may also be configured to concentrate magnetic field emanating from second antenna 510 away from certain circuit and/or components situated proximately to second antenna 510.

As described above, in an embodiment, first antenna 508 may be a NFC antenna, and second antenna 510 may be a WPT antenna. In accordance with this embodiment, the WPT antenna may be a smaller non-resonant tightly-coupled antenna that is surrounded by a larger NFC antenna. Due to the smaller size of the tightly-coupled antennas, typically only a single device is able to be charged using the non-resonant tightly-coupled antenna, although this embodiment is not limited to charging a single device.

In an embodiment, where the ability to charge a plurality of devices simultaneously is desired, the WPT antenna may be a larger resonant loosely-coupled antenna that surrounds a smaller NFC antenna. Accordingly, in one embodiment, first antenna 508 is a loosely-coupled WPT antenna, and second antenna 510 is an NFC antenna. In accordance with this embodiment, the loosely-coupled WPT antenna is a larger coil that rings the smaller coil of the NFC antenna. The larger loosely-coupled WPT antenna allows for a greater freedom of placement for the device(s) to be charged.

In an embodiment, assembly 500 is disposed in a charging pad configured to wirelessly charge a plurality of devices (e.g., a cellphone, tablet, Bluetooth headset, etc.) placed adjacently thereto (e.g., on top of a charging pad).

Example Heterogeneous Shielding Layer Having Characteristically-Uniform Regions that are Separated by a Gap

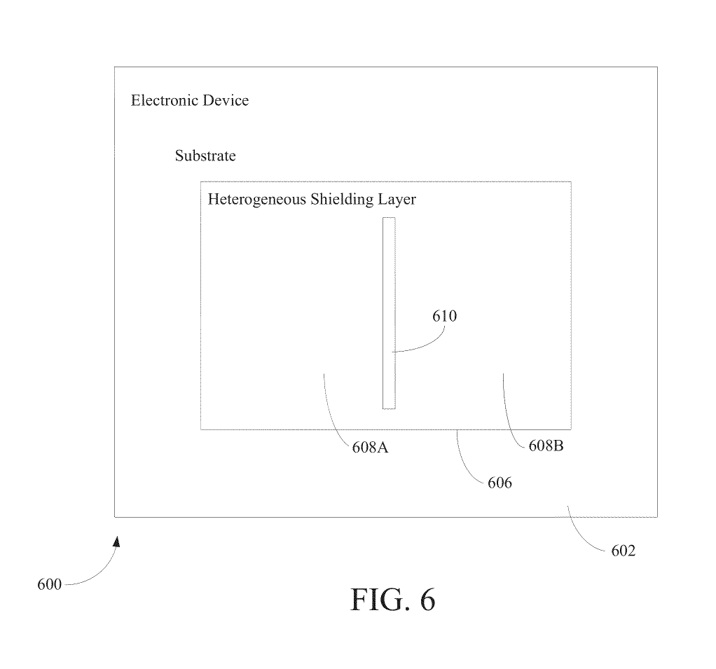

According to another example embodiment, FIG. 6 depicts a block diagram 600 of an electronic device 602. Electronic device 602 may be a device such as, but not limited to, a mobile device including a cell phone (e.g., a smart phone), a tablet, a netbook, a personal data assistant (PDA), a laptop computer, a handheld computer, or other mobile device, or may be a stationary device such as a desktop computer, and/or the like. Electronic device 602 may include further features that are not shown in FIG. 6 for ease of illustration.

As shown in FIG. 6, heterogeneous shielding layer 606 has a first region 608A and a second region 608B that are characteristically-uniform with respect to each other (as opposed to first and second regions 206A and 206B described above with respect to FIG. 2A). For example, first region 608A and second region 608B may be formed of the same material, have the same thickness and the same permeability. In accordance with an embodiment, the material from which first region 608A and second region 608B is formed may be configured to concentrate magnetic field lines emanating from a plurality of antennas (not shown) of electronic device 602, in a similar manner as described above.

For example, in accordance with an embodiment, first region 608A may be configured to be positioned adjacent to a first antenna and second region 608B may be configured to be positioned adjacent to a second antenna. For instance, the first antenna may be configured to be situated on top of first region 608A, and the second antenna may be configured to be situated on top of second region 608B. In one example embodiment, the first antenna is an NFC antenna, and the second antenna is a WPT antenna.

To reduce the coupling between the magnetic field lines emanating from the two antennas, first region 608A and second region 608B are separated by a gap 610 that is formed in heterogeneous shielding layer 606.

In the example shown in FIG. 6, heterogeneous shielding layer 606 includes a single, rectangular gap (i.e., gap 610) that is positioned approximately in the center of heterogeneous shielding layer 606. In alternative embodiments, heterogeneous shielding layer 606 may include any number of gaps that are formed in any location of heterogeneous shielding layer 606. In addition, each gap may have other shapes, such as being, round (e.g., forming a round ring-shaped gap), triangular, polygonal, irregularly shaped, etc.

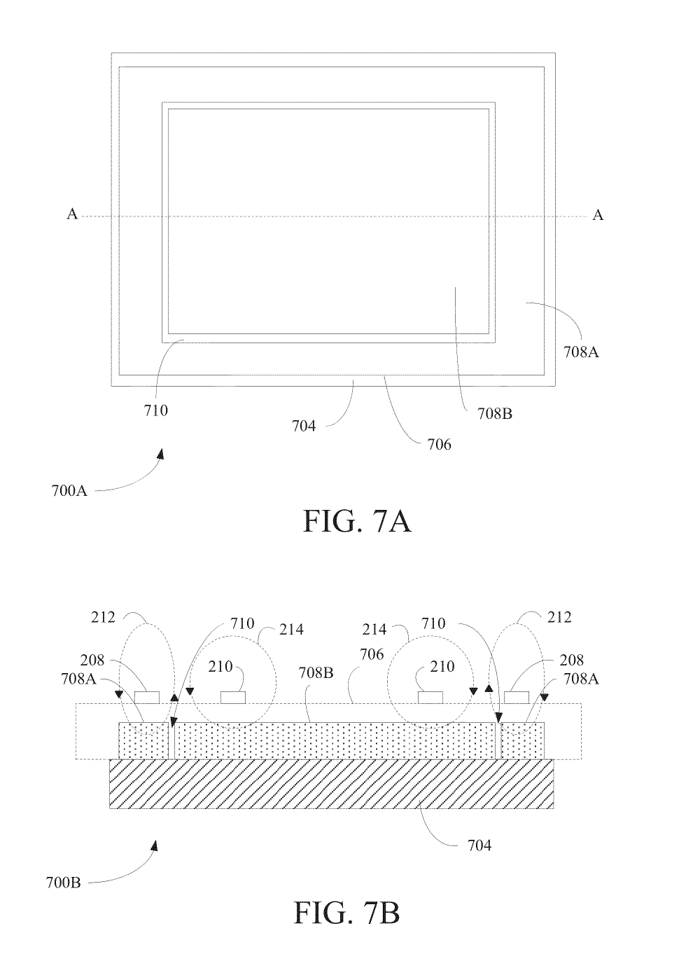

For instance, FIG. 7A shows an overhead view 700A of a heterogeneous shielding layer 706, where a gap 710 is formed such that heterogeneous shielding layer 706 is separated into a first region 708A and a second region 708B. FIGS. 7B-7D show cross-sectional views 700B-700D, respectively, of heterogeneous shielding layer 706 along the line A-A of the overhead view 700A shown in FIG. 7A.

In an embodiment, as shown in FIGS. 7A-7D, heterogeneous shielding layer 706 is formed over a substrate 704. Substrate 704 is generally similar to substrate 202 shown in FIGS. 2B-2E and described above. It is noted that substrate 704 is optional and not required in all embodiments. It is further noted that additional materials and/or layers (e.g., adhesive layers) may be present in between and/or affixed adjacently to substrate 704 and/or heterogeneous shielding layer 706 that are not shown in FIGS. 7A-7D for ease of illustration.

First region 708A and second region 708B may be formed of a same material. The material is configured to concentrate magnetic field lines. In one embodiment, the material is a ferrite material. Alternatively, the material may be any other material disclosed herein or otherwise known that may be configured to concentrate magnetic field lines. Gap 710 is formed to reduce the coupling between the magnetic field lines emanating from a first antenna that is positioned adjacent (e.g., situated over) to first region 708A and the magnetic field lines emanating from a second antenna that is positioned adjacent to second region 708B. As shown in FIG. 7A, gap 710 may be configured to be ring-shaped. By doing so, first region 708A rings second region 708B. Gap 710 may be formed using any suitable manner, including by etching, etc. While the ring-shaped gap (i.e., gap 710) is depicted to be rectangular, it is noted that the ring-shaped gap may have other shapes, such as being, circular, polygonal, irregularly shaped, etc.

In embodiments, heterogeneous shielding layer 706 with gap 710 is configured to concentrate magnetic fields generated by adjacent antennas. For instance, FIG. 7B shows a cross-sectional view of one loop (or coil) of first antenna 208 positioned adjacent to first region 708A and of one loop of second antenna 210 positioned adjacent to second region 708B. As such, gap 710 is present in heterogeneous shielding layer 706 between first and second antennas 208 and 210. Additional loops/coils of antennas 208 and 210, which may be present, are not shown in FIG. 7B for ease of illustration. Furthermore, for ease of illustration, antennas 208 and 210 are not shown in FIGS. 7A, 7C, and 7D. As shown in FIG. 7B, first magnetic field lines 212 generated by first antenna 208 are concentrated in first region 708A, and second magnetic field lines 214 generated by second antenna 210 are concentrated in second region 708B, as separated by gap 710.

As shown in FIG. 7B, in accordance with an embodiment, gap 710 may be formed such that it completely extends all the way through heterogeneous shielding layer 706. In accordance with another embodiment, as shown in FIG. 7C, gap 710 may be formed such that it partially extends through heterogeneous shielding layer 706 (has a depth that is less than a thickness of heterogeneous shielding layer 706).

In accordance with yet another embodiment, as shown in FIG. 7D, gap 710 may have varying widths. For example, a first portion 712 of gap 708 has a first width of w1 and a second portion 714 of gap 708 has a second width of w2, where w1 is wider than w2. The coupling effect between the magnetic field lines emanating from the first antenna and the magnetic field lines emanating from the second antenna (not shown in FIG. 7D) is reduced as the width of gap 710 is increased. Thus, certain portions of gap 710 may be formed to have a wider width than other portions of gap 710 in regions where the distance between the first antenna and the second antenna are greater than other regions between the first antenna and the second antenna.

In accordance with a further embodiment, gap 710 may be filled with a material (e.g., such as an insulating material) to further reduce the coupling between the magnetic field lines emanating from the first antenna and the magnetic field lines emanating from the second antenna. In one embodiment, gap 710 is filled with the insulating material such that a top surface of heterogeneous shielding layer 706 is coplanar with a top surface of the insulating material. In another embodiment, gap 710 is filled with the insulating material such that the top surface of heterogeneous shielding layer 706 is not coplanar with the top surface of insulating layer.

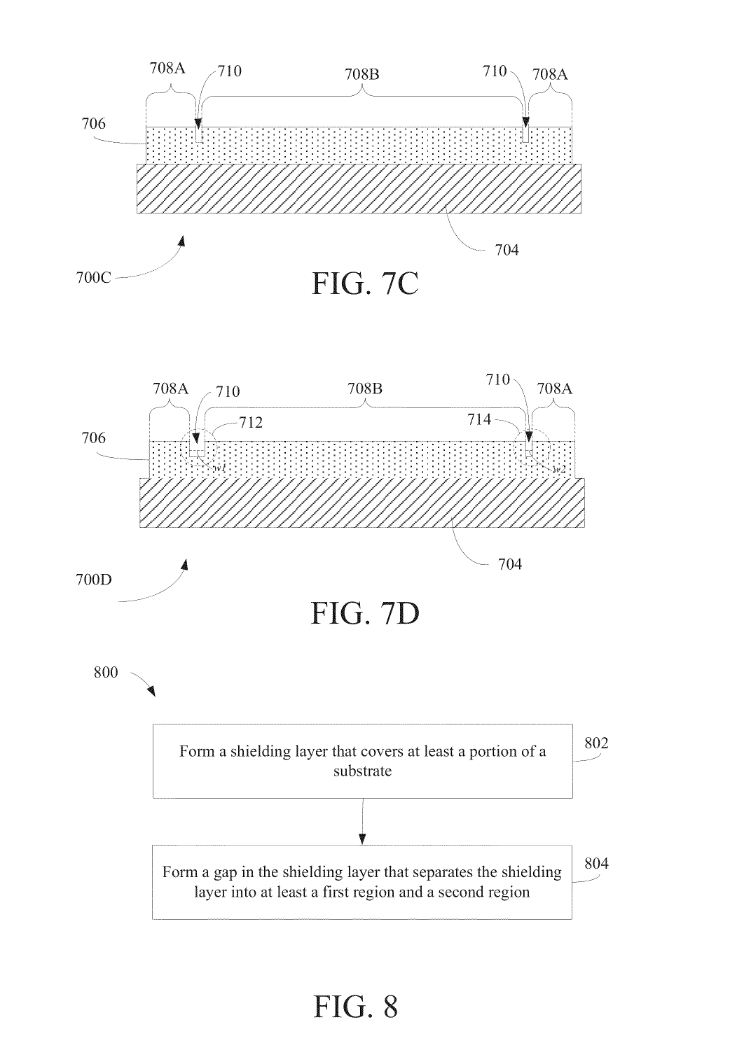

Heterogeneous shielding layer 706 may be formed in various ways, in embodiments. For instance, FIG. 8 shows a flowchart 800 providing example steps for forming a heterogeneous shield layer, according to an example embodiment. Heterogeneous shielding layer 706 of FIGS. 7A-7D may be formed according to flowchart 800. Flowchart 800 is described as follows.

As shown in FIG. 8, flowchart 800 beings with step 802. In step 802, a shielding layer that covers at least a portion of a substrate is formed. For example, as shown in each of FIGS. 7A-7D, heterogeneous shielding layer 706 is formed on substrate 704. Heterogeneous shielding layer 706 may be formed in any manner, including by flowing the base material in a mold and allowing the material to harden to form heterogeneous shielding layer 706, by cutting, milling, or otherwise shaping heterogeneous shielding layer 706 from a base solid material, or by forming heterogeneous shielding layer 706 in another manner otherwise known or described elsewhere herein. When heterogeneous shielding layer 706 is formed from regions that are completely separated by gap 710, the separate regions of heterogeneous shielding layer 706 may be formed in a generally similar manner as described above for heterogeneous shielding layer 204.

At step 804, a gap in the shielding layer is formed that separates the shielding layer into at least two regions. For example, with reference to FIG. 7A, gap 710 is formed, which separates heterogeneous shielding layer 706 into first region 708A and 708B. When heterogeneous shielding layer 706 is formed in step 802 in a single piece, gap 710 may be formed in any manner, such as by milling, sawing, stamping, and/or in any other manner. Otherwise, gap 710 may be formed by sizing the separate regions/pieces to have gap 710 between them.

In an embodiment, each of the at least two regions of the shielding layer are configured to concentrate magnetic field lines. The at least two regions are formed of a same material. In accordance with this embodiment, the same material may be a ferrite material, or other suitable magnetic shielding material mentioned elsewhere herein or otherwise known.

In accordance with another embodiment, a first region of the at least two regions may ring a second region of the at least two regions. For example, with reference to FIG. 7A, first region 708A rings second region 708B.

In accordance with yet another embodiment, a first portion of the gap has a first width and a second portion of the gap has a second width, where the first width is different from the second width. For example, with reference to FIG. 7D, a first portion 712 of gap 710 has a first width of w1 and a second portion 714 of gap 710 has a second width of w2, where w1 is wider than w2.

In still another embodiment, flowchart 800 may include the step of inserting an insulating material in gap 710. As described above, the insulating material may further reduce the coupling between the magnetic field lines emanating from the first antenna and the magnetic field lines emanating from the second antenna. The insulating material may be any suitable insulating material, such as an electrically insulating epoxy, a plastic or polymer, a glass material, or other suitable material.

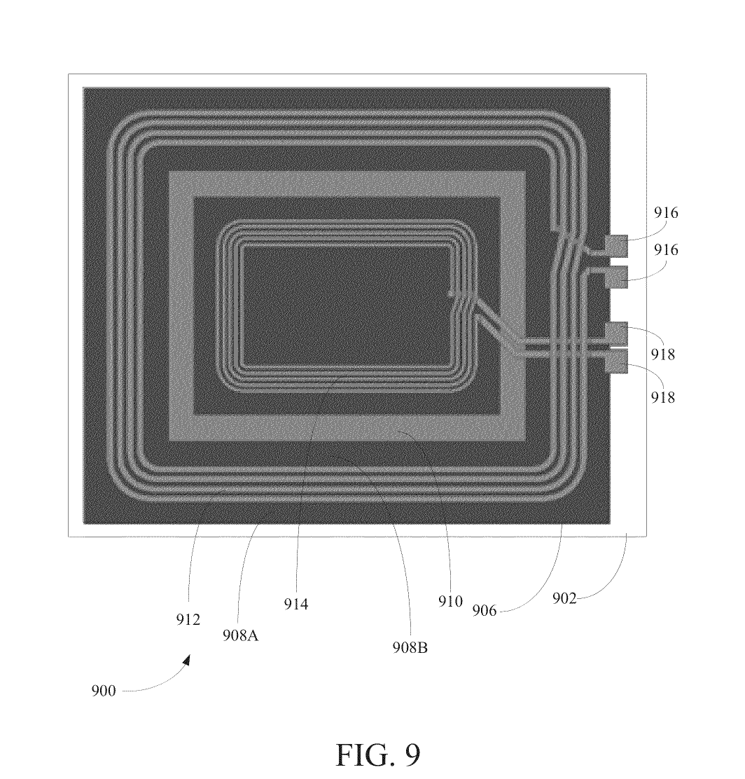

Heterogeneous shielding layers with gaps between regions may be implemented in devices in any manner. For instance, FIG. 9 shows an overhead view of an example assembly 900 including a heterogeneous shielding layer in accordance with embodiments described herein. For example, assembly 900 includes a substrate 902, a heterogeneous shielding layer 906, a first antenna 912, and a second antenna 914. Substrate 902 includes heterogeneous shielding layer 906 formed thereon. Heterogeneous shielding layer 906 includes a gap 910 that separates heterogeneous shielding layer 906 into a first region 908A and a second region 908B. First region 908A is positioned adjacent to first antenna 912. For example, as shown in FIG. 9, first antenna 912 is situated on top of first region 908A. Second region 908B is positioned adjacent to second antenna 914. For example, as shown in FIG. 9, second antenna 914 is situated on top of second region 908B. As such, gap 910 is present in heterogeneous shielding layer 906 between first and second antennas 912 and 914. Gap 910 may be formed, positioned, and/or sized in a similar manner as gap 710 described above, and/or in other ways.

While FIG. 9 depicts first antenna 912 as being irregularly shaped and depicts second antenna 914 as being a rectangular shape with rounded corners, it is noted that first antenna 912 and second antenna 914 may have other shapes, such as being round, triangular, polygonal, etc.

Assembly 900 further includes first connectors 916 and second connectors 918 that are generally similar to first and second connectors 512 and 514 described above. First connectors 916 are coupled to first antenna 912. Second connectors 918 are coupled to second antenna 914. First connectors 916 and second connectors 918 are configured to couple first antenna 912 and second antenna 914, respectively, to other circuitry of the device in which assembly 900 is housed. First connectors 916 and second connectors 918 are located on a different plane with first antenna 912 and second antenna 914 (i.e., they are not coplanar with first antenna 912 and second antenna 914) to prevent a short circuit between first and second connectors 916, 918 and first and second antennas 912, 914.

First region 908A and second region 908B may be formed of the same material (e.g., a ferrite material). The material is configured to concentrate magnetic field lines. For example first region 908A is configured to concentrate magnetic field lines emanating from first antenna 912, and second region 908B is configured to concentrate magnetic field lines emanating from second antenna 914.

In an embodiment, first antenna 912 may be a near-field communication (NFC) antenna, and second antenna 914 may be a WPT antenna. WPT antennas have been shown to emanate stronger magnetic field lines than NFC antennas. As such, the magnetic field lines emanating from WPT antennas may cause a coupling effect with the magnetic field lines emanating from the NFC antenna, which hinders the performance of WPT antenna and/or the NFC antenna. Gap 910 is formed to reduce such a coupling effect.

First antenna 912 may be a NFC antenna, and second antenna 914 may be a WPT antenna. In accordance with this embodiment, the WPT antenna may be a smaller non-resonant tightly-coupled antenna that is surrounded by a larger NFC antenna. Due to the smaller size of the tightly-coupled antennas, typically only a single device is able to be charged using the non-resonant tightly-coupled antenna. In an embodiment, where the ability to charge a plurality of devices simultaneously is desired, the WPT antenna may be a larger resonant loosely-coupled antenna that surrounds a smaller NFC antenna.

Accordingly, in an embodiment, first antenna 912 is a loosely-coupled WPT antenna, and second antenna 914 is an NFC antenna. First and second antennas 912 and 914 are configured in FIG. 9 similarly to first and second antennas 508 and 510 shown in FIG. 5 and described above. As shown, the loosely-coupled WPT antenna is a larger coil that rings the smaller coil of the NFC antenna. The larger loosely-coupled WPT antenna allows for a greater freedom of placement for the device(s) to be charged.

In an embodiment, assembly 900 is disposed in a charging pad configured to wirelessly charge a plurality of devices (e.g., a cellphone, tablet, Bluetooth headset, etc.) placed adjacently thereto (e.g., on top of the charging pad).

### CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. An apparatus, comprising:
a shielding layer formed of at least one material configured to concentrate magnetic field lines,
wherein the shielding layer includes a first region that has a first characteristic and a second region that has a second characteristic that is different from the first characteristic, and
wherein the first region is configured to be positioned adjacent to at least a first antenna and the second region is configured to be positioned adjacent to at least a second antenna.

2. The apparatus of claim 1, wherein the first characteristic of the first region is a first permeability and the second characteristic of the second region is a second permeability, the first permeability being different from the second permeability.

3. The apparatus of claim 1, wherein the first characteristic of the first region is a first thickness and the second characteristic of the second region is a second thickness, the first thickness being different from the first thickness.

4. The apparatus of claim 1, further comprising:
a gap that separates the first region from the second region.

5. The apparatus of claim 1, wherein the second region rings the first region.

6. The apparatus of claim 1, wherein the first antenna is a near field communication (NFC) antenna and the second antenna is a wireless power transfer (WPT) antenna.

7. The apparatus of claim 1, wherein the at least one material comprises a ferrite material.

8. The apparatus of claim 1, wherein the shielding layer is formed of at least two materials that are each configured to concentrate magnetic field lines, wherein the first region comprises a first material of the at least two materials and the second region comprises a second material of the at least two materials, the first material being different from the second material.

9. The apparatus of claim 8, wherein the first material comprises a first ferrite material and the second material comprises a second ferrite material, the first ferrite material being different from the second ferrite material.

10. An apparatus, comprising:
a shielding layer having at least two regions separated by a gap,
wherein the at least two regions are formed of a same material,
wherein each of the at least two regions are configured to concentrate magnetic field lines, and
wherein the shielding layer is configured to be positioned adjacent to a plurality of antennas.

11. The apparatus of claim 10, wherein the same material comprises a ferrite material.

12. The apparatus of claim 10, wherein a first region of the at least two regions has a first thickness and a second region of the at least two regions has a second thickness, the first thickness being different from the second thickness.

13. The apparatus of claim 10, wherein a first region of the at least two regions rings a second region of the at least two regions.

14. The apparatus of claim 10, wherein a first antenna of the plurality of antennas is a near field communication (NFC) antenna and a second antenna of the plurality of antennas is a wireless power transfer (WPT) antenna.

15. A method for forming a shielding layer, comprising:
forming a first region of the shielding layer that covers a first portion of a substrate, the first region having a first characteristic; and
forming a second region of the shielding layer having a second characteristic that covers a second portion of the substrate, the first portion being different than the second portion.

16. The method of claim 15, further comprising:
forming a gap that separates the first region from the second region.

17. The method of claim 15, wherein a first region rings the second region.

18. The method of claim 15, wherein the first characteristic of the first region is a first permeability value and the second characteristic of the second region is a second permeability value, the first permeability value being different from the second permeability value.

19. The method of claim 15, wherein the first characteristic of the first region is a first thickness and the second characteristic of the second region is a second thickness, the first thickness being different from the first thickness.

20. The method of claim 15, wherein the first region and the second region comprise a ferrite material.
